(19) United States
(12) Patent Application Publication
(10) Pub. No.: US 2006/0076424 A1
(43) Pub. Date: Apr. 13, 2006

(54) Data processing system and method

(75) Inventors: Ming-Chou Yen, Hsinchu (TW); Kun-Ying Tsai, Hsinchu (TW); Jui-Tai Ko, Hsinchu (TW); Chun-Wang Wei, Hsinchu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/075,468

(22) Filed: Mar. 8, 2005

(30) Foreign Application Priority Data
Oct. 13, 2004 (TW) 093130964

(51) Int. Cl. G06K 19/06

(52) U.S. Cl. 235/494

(57) ABSTRACT

A data processing system and method are provided. A first combination logical encoding unit encodes a first set of encryption data to create digital symbols and outputs the digital symbols to an analog/digital symbol processing unit. Further, a combination logical decoding unit performs logical operations to transform a first set of multi-dimensional digital symbols converted from multi-dimensional analog symbols received from a network via the analog/digital symbol processing unit to create a second set of encryption data. Then, the analog/digital symbol processing unit outputs the second encryption data to a second combination logical encoding unit where the second set of encryption data is encoded to create a second set of multi-dimensional digital symbols. A comparing unit then compares the first and second sets of multi-dimensional digital symbols to determine the validity of the first set. The data processing system and method of the present invention reduces the cost on hardware implementation of a data transmitting/receiving interface for data processing and transformation, especially on the implementation of a storage unit.

### FIELD OF THE INVENTION

The present invention relates to data processing systems and methods and, more particularly, to a data processing system and method applicable to a network data transmitting interface.

### BACKGROUND OF THE INVENTION

In 1995, the IEEE 802.3 Committee organized a workforce to research how to achieve Gigabit-level transmission rate for packets transmitted within an Ethernet environment. Today, Gigabit Ethernet technology and standard has come to maturity. Some successful applications thereof have been developed. Gigabit Ethernet not only defines new medium and transmission protocols, but also retains the protocols and error detection formats of the 10M and 100M Ethernet, so as to have downward compatibility. As more and more people are using the 100M Ethernet, more-and more transactions are carried on the backbone of Ethernet. The need for Gigabit Ethernet thus emerges. A 4-dimension Pulse Amplitude Modulation-5level (4D-PAM5) encoding technique is used for Gigabit Ethernet using Universal Personal Telecommunication (UPT) as a transmission medium, the 4D-PAM5 encoding technique simultaneously transmits/receives data on four pairs of unshielded twisted-pair cables in full-duplex mode.

In order to transmit digital data over the Internet, the data processing system in the Ethernet needs to convert digital data to multi-dimensional analog symbols suitable for transmitting on the Ethernet to a remote electronic system. The current 4D-PAM5 based communication system creates a mapping table to be stored in a storage unit, for example, a ROM, based on a mapping relationship between the digital data and multi-dimensional digital symbols. When transmitting data, the bit-symbol mapping table is first searched for corresponding multi-dimensional digital symbols, and the multi-dimensional digital symbols are converted into multi-dimensional analog symbols suitable for transmission. When receiving data from the network, the multi-dimensional analog symbols sent will need to be converted back to multi-dimensional digital symbols, then digital data that correspond to the multi-dimensional digital symbols are looked up from a symbol-bit mapping table stored in the storage unit.

However, carrying out transformation between the digital data and the multi-dimensional digital symbols requires the use of the memory cell (for example ROM) for storing the bit-symbol mapping table and the symbol-bit mapping table. Also, a large number of logical gates are required to design the ROM, increasing the cost of the production and hardware design complexity.

Thus, there is a need for carrying out transformation between the digital and the multi-dimensional digital symbols by means of logical operation without storage units that improves data transmission rate and reliability and reduces the cost of the production.

### SUMMARY OF INVENTION

In light of the described disadvantages in the prior art, it is an objective of the present invention to provide a data processing system and method to reduce the cost of production and increase reliability of data transmission.

In accordance with the foregoing and other objectives, the invention proposes a data processing system, which comprises a first combination logical encoding unit for performing a logical operation to encode a first set of encryption data to create digital symbols and output the digital symbols to an analog/digital symbol processing unit; a combination logical decoding unit for performing a logical operation to decode a first set of multi-dimensional digital symbols to create a second set of encryption data, wherein the first set of multi-dimensional digital symbols is converted from multi-dimensional analog symbols received from the network by the analog/digital symbol processing unit; a second combination logical encoding unit for receiving the second set of encryption data from the analog/digital symbol processing unit, and encoding the second set of encryption data to create a second set of multi-dimensional digital symbols; and a comparing unit, which compares the first and second sets of multi-dimensional digital symbols to check the validity of the first set.

The present invention also proposes a data processing method, which can be used in the data processing system of the present invention, the method comprises the following steps: (1) providing a first combination logical encoding unit for performing a logical operation to encode a first set of encryption data to create and output digital symbols to the analog/digital symbol-processing unit; (2) providing a combination logical decoding unit for performing a logical operation on a first set of multi-dimensional digital symbols converted from multi-dimensional analog symbols received by the analog/digital symbol-processing unit from a network to create a second set of encryption data; (3) providing the second combination logical encoding unit for receiving the second set of encryption data from the analog/digital symbol-processing unit, and encoding the second set of encryption data to create a second set of multi-dimensional digital symbols; and (4) providing the comparing unit for comparing the first and second sets of multi-dimensional digital symbols to check the validity of the first set.

Compared with the conventional technology, the data processing system of the present invention can perform a logical operation to carry out the transformation between a bit data and a symbol directly without employing a storage unit, thus reducing the cost of product. Further, the reliability of data transmission can be guaranteed by means of checking the validity of the first set of multi-dimensional digital symbols.

### BRIEF DESCRIPTION OF THE DRAWINGS

The present invention can be more fully understood by reading the following detailed description of the preferred embodiments with reference to the accompanying drawings, wherein:

FIG. 1 is a schematic diagram of a data processing system of the present invention; and

FIG. 2 is a flowchart that depicts a data processing method applied to the system as shown in FIG. 1.

### DETAILED DESCRIPTION OF THE INVENTION

In accordance with the present invention, various specific embodiments are disclosed in full details in the following with reference to the accompanying drawings.

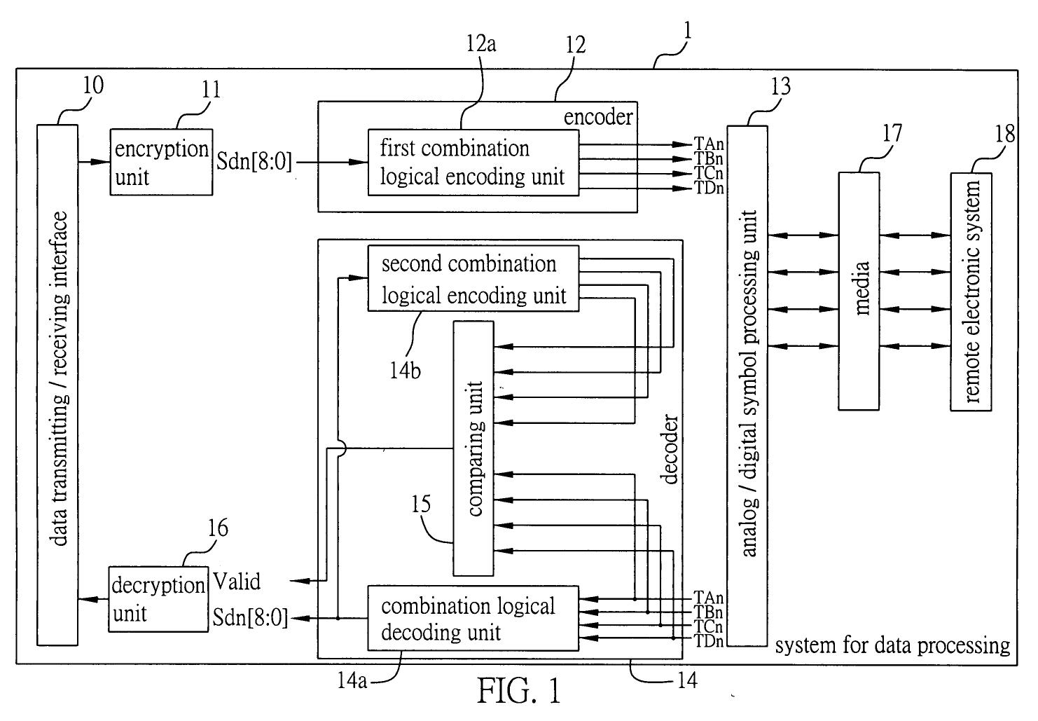

Referring to FIG. 1, which is a schematic diagram of a data processing system of the present invention, the data processing system 1 of the present invention comprises a data transmitting/receiving interface 10, an encryption unit 11, an encoder 12, an analog/digital symbol processing unit 13, a decoder 14, a comparing unit 15 and a decryption unit 16.

The data transmitting/receiving interface 10 is used for transmitting/receiving data dₙ[7:0] in the form of an 8-bit data stream.

The encryption unit 11 is used for encrypting the bit stream transmitted by the data transmitting/receiving interface 10 to a first set of encryption data Sdₙ[8:0] and outputting the first set of encryption data Sdₙ[8:0].

The encoder 12 is used for performing a logical operation to encode the first set of encryption data Sdₙ[8:0] to create multi-dimensional (e.g., 4-dimensional) digital symbols {TA, TB, TC, TD} for output. In this embodiment, the encoder 12 comprises at least a first combination logical encoding unit 12a.

The analog/digital symbol processing unit 13 is used for converting the multi-dimensional digital symbols to multi-dimensional (e.g., 4-dimensional) analog symbols {A, B, C, D} and transmitting the analog symbols to the network; and converting multi-dimensional analog symbols {A, B, C, D} received from the network to a first set of multi-dimensional digital symbols {TA, TB, TC, TD}.

In this embodiment, the decoder 14 comprises at least a combination logical decoding unit 14a and a second combination logical encoding unit 14b. The decoder 14 performs a logical operation to decode the first set of multi-dimensional digital symbols to create second set of encryption data Sdₙ[8:0], and outputs the second set of encryption data Sdₙ[8:0] to the second combination logical encoding unit 14b, where the second set of encryption data Sdₙ[8:0] is encoded to create a second set of multi-dimensional digital symbols. More specifically, the combination logical decoding unit 14a performs a logical operation to decode the first set of multi-dimensional digital symbols to create the second set of encryption data, where the first set of multi-dimensional digital symbols are converted from multi-dimensional analog symbols received from the network by the analog/digital symbol processing unit 13. The second combination logical encoding unit 14b encodes the second set of encryption data received from the analog/digital symbol processing unit 13 to create the second set of multi-dimensional digital symbols.

The comparing unit 15 is used for comparing the first set of multi-dimensional digital symbols with the second set of multi-dimensional digital symbols to check the validity of the first set of multi-dimensional digital symbols.

The decryption unit 16 is used for decrypting the second set of encryption data to a digital data suitable for reception by the data transmitting/receiving interface 10. The data processing system 1 further comprises: a medium 17 for transmitting the multi-dimensional analog symbols; and a remote electronic system 18 for receiving/transmitting the multi-dimensional analog symbols via the medium 17.

The Ethernet is based on the IEEE 802.3 standard. The mapping relationship between the first set of encryption data Sdₙ[8:0] and the multi-dimensional digital symbols {TA, TB, TC, TD} is predefined, and where

TA, TB, TC, TD ∈ {+2, +1,0,−1,−2},

A, B, C, D E {+2, +1,0,−1,−2}.

Besides, 8 subsets are further defined as follow:
{EEEE ∪ OOOO}, {EEOO ∪ OOEE},
{EOOE ∪ OEEO}, {EOEO ∪ OEOE},
{EEEO ∪ OOOE}, {EEOE ∪ OOEO},
{EOOO ∪ OEEE}, {EOEE ∪ OEOO},

wherein, E ∈ (0,+2,−2) and 0 ∈ (+1,−1). 010 represents +2, 110 represents −2, 000 represents +1, and 111 represents −1. The analog symbols A, B, C, and D are simultaneously transmitted to the medium 17 in parallel, and transmitted to the remote electronic system 18 via the medium 17. The bit-symbol mapping relationship of the data Sdₙ[8:0] and the symbols {TA, TB, TC, TD} is shown in Table 1, as follows:

TABLE 1

| | | Sdₙ [6:8] = | Sdₙ [6:8] = | Sdₙ [6:8] = | Sdₙ [6:8] = |
|---|---|---|---|---|---|
| | | [000] | [010] | [100] | [110] |
| | | TAₙ, TBₙ, | TAₙ, TBₙ, | TAₙ, TBₙ, | TAₙ, TBₙ, |
| Condition | Sdn[5:0] | TCₙ, TDₙ | TCₙ, TDₙ | TCₙ, TDₙ | TCₙ, TDₙ |
| Normal | 000000 | 0, 0, 0, 0 | 0, 0, +1, +1 | 0, +1, +1, 0 | 0, +1, 0, +1 |
| Normal | 000001 | −2, 0, 0, 0 | −2, 0, +1, +1 | −2, +1, +1, 0 | −2, +1, 0, +1 |
| Normal | 000010 | 0, −2, 0, 0 | 0, −2, +1, +1 | 0, −1, +1, 0 | 0, −1, 0, +1 |
| Normal | 000011 | −2, −2, 0, 0 | −2, −2, +1, +1 | −2, −1, +1, 0 | −2, −1, 0, +1 |
| Normal | 000100 | 0, 0, −2, 0 | 0, 0, −1, +1 | 0, +1, −1, 0 | 0 +1, −2, +1 |
| Normal | 000101 | −2, 0, −2, 0 | −2, 0, −1, +1 | −2, +1, −1, 0 | −2, +1, −2, +1 |
| Normal | 000110 | 0, −2, −2, 0 | 0, −2, −1, +1 | 0, −1, −1, 0 | 0 −1, −2, +1 |
| Normal | 000111 | −2, −2, −2, 0 | −2, −2, −1, +1 | −2, −1, −1, 0 | −2, −1, −2, +1 |
| Normal | 001000 | 0, 0, 0, −2 | 0, 0, +1, −1 | 0, +1, +1, −2 | 0, +1, 0, −1 |
| Normal | 001001 | −2, 0, 0, −2 | −2, 0, +1, −1 | −2, +1, +1, −2 | −2, +1, 0, −1 |
| Normal | 001010 | 0, −2, 0, −2 | 0, −2, +1, −1 | 0, −1, +1, −2 | 0, −1, 0, −1 |
| Normal | 001011 | −2, −2, 0, −2 | −2, −2, +1, −1 | −2, −1, +1, −2 | −2, −1, 0, −1 |
| Normal | 001100 | 0, 0, −2, −2 | 0, 0, −1, −1 | 0, +1, −1, −2 | 0, +1, −2, −1 |
| Normal | 001101 | −2, 0, −2, −2 | −2, 0, −1, −1 | −2, +1, −1, −2 | −2, +1, −2, −1 |
| Normal | 001110 | 0, −2, −2, −2 | 0, −2, −1, −1 | 0, −1, −1, −2 | 0, −1, −2, −1 |
| Normal | 001111 | −2, −2, −2, −2 | −2, −2, −1, −1 | −2, −1, −1, −2 | −2, −1, −2, −1 |
| Normal | 010000 | +1, +1, +1, +1 | +1, +1, 0, 0 | +1, 0, 0, +1 | +1, 0, +1, 0 |
| Normal | 010001 | −1, +1, +1, +1 | −1, +1, 0, 0 | −1, 0, 0, +1 | −1, 0, +1, 0 |
| Normal | 010010 | +1, −1, +1, +1 | +1, −1, 0, 0 | +1, −2, 0, +1 | +1, −2, +1, 0 |
| Normal | 010011 | −1, −1, +1, +1 | −1, −1, 0, 0 | −1, −2, 0, +1 | −1, −2, +1, 0 |
| Normal | 010100 | +1, +1, −1, +1 | +1, +1, −2, 0 | +1, 0, −2, +1 | +1, 0, −1, 0 |
| Normal | 010101 | −1, +1, −1, +1 | −1, +1, −2, 0 | −1, 0, −2, +1 | −1, 0, −1, 0 |
| Normal | 010110 | +1, −1, −1, +1 | +1, −1, −2, 0 | +1, −2, −2, +1 | +1, −2, −1, 0 |
| Normal | 010111 | −1, −1, −1, +1 | −1, −1, −2, 0 | −1, −2, −2, +1 | −1, −2, −1, 0 |
| Normal | 011000 | +1, +1, +1, −1 | +1, +1, 0, −2 | +1, 0, 0, −1 | +1, 0, +1, −2 |
| Normal | 011001 | −1, +1, +1, −1 | −1, +1, 0, −2 | −1, 0, 0, −1 | −1, 0, +1, −2 |
| Normal | 011010 | +1, −1, +1, −1 | +1, −1, 0, −2 | +1, −2, 0, −1 | +1, −2, +1, −2 |
| Normal | 011011 | −1, −1, +1, −1 | −1, −1, 0, −2 | −1, −2, 0, −1 | −1, −2, +1, −2 |
| Normal | 011100 | +1, +1, −1, −1 | +1, +1, −2, −2 | +1, 0, −2, −1 | +1, 0, −1, −2 |
| Normal | 011101 | −1, +1, −1, −1 | −1, +1, −2, −2 | −1, 0, −2, −1 | −1, 0 −1, −2 |
| Normal | 011110 | +1, −1, −1, −1 | +1, −1, −2, −2 | +1, −2, −2, −1 | +1, −2, −1, −2 |
| Normal | 011111 | −1, −1, −1, −1 | −1, −1, −2, −2 | −1, −2, −2, −1 | −1, −2, −1, −2 |
| Normal | 100000 | +2, 0, 0, 0 | +2, 0, +1, +1 | +2, +1, +1, 0 | +2, +1, 0, +1 |
| Normal | 100001 | +2, −2, 0, 0 | +2, −2, +1, +1 | +2, −1, +1, 0 | +2, −1, 0, +1 |
| Normal | 100010 | +2, 0, −2, 0 | +2, 0, −1, +1 | +2, +1, −1, 0 | +2, +1, −2, +1 |
| Normal | 100011 | +2, −2, −2, 0 | +2, −2, −1, +1 | +2, −1, −1, 0 | +2, −1, −2, +1 |
| Normal | 100100 | +2, 0, 0, −2 | +2, 0, +1, −1 | +2, +1, +1, −2 | +2, +1, 0, −1 |
| Normal | 100101 | +2, −2, 0, −2 | +2, −2, +1, −1 | +2, −1, +1, −2 | +2, −1, 0, −1 |
| Normal | 100110 | +2, 0, −2, −2 | +2, 0, −1, −1 | +2, +1, −1, −2 | +2, +1, −2, −1 |
| Normal | 100111 | +2, −2, −2, −2 | +2, −2, −1, −1 | +2, −1, −1, −2 | +2, −1, −2, −1 |
| Normal | 101000 | 0, 0, +2, 0 | +1, +1, +2, 0 | +1, 0, +2, +1 | 0, +1, +2, +1 |
| Normal | 101001 | −2, 0, +2, 0 | −1, +1, +2, 0 | −1, 0, +2, +1 | −2, +1, +2, +1 |
| Normal | 101010 | 0, −2, +2, 0 | +1, −1, +2, 0 | +1, −2, +2, +1 | 0, 1, +2, +1 |
| Normal | 101011 | −2, −2, +2, 0 | −1, −1, +2, 0 | −1, −2, +2, +1 | −2, −1, +2, +1 |
| Normal | 101100 | 0, 0, +2, −2 | +1, +1, +2, −2 | +1, 0, +2, −1 | 0, +1, +2, −1 |
| Normal | 101101 | −2, 0, +2, −2 | −1, +1, +2, −2 | −1, 0, +2, −1 | −2, +1, +2, −1 |
| Normal | 101110 | 0, −2, +2, −2 | +1, −1, +2, −2 | +1, −2, +2, −1 | 0, −1, +2, −1 |
| Normal | 101111 | −2, −2, +2, −2 | −1, −1, +2, −2 | −1, −2, +2, −1 | −2, −1, +2, −1 |
| Normal | 110000 | 0, +2, 0, 0 | 0, +2, +1, +1 | +1, +2, 0, +1 | +1, +2, +1, 0 |
| Normal | 110001 | −2, +2, 0, 0 | −2, +2, +1, +1 | −1, +2, 0, +1 | −1, +2, +1, 0 |
| Normal | 110010 | 0, +2, −2, 0 | 0, +2, −1, +1 | +1, +2, −2, +1 | +1, +2, −1, 0 |
| Normal | 110011 | −2, +2, −2, 0 | −2, +2, −1, +1 | −1, +2, −2, +1 | −1, +2, −1, 0 |
| Normal | 110100 | 0, +2, 0, −2 | 0, +2, +1, −1 | +1, +2, 0, −1 | +1, +2, +1, −2 |
| Normal | 110101 | −2, +2, 0, −2 | −2, +2, +1, −1 | −1, +2, 0, −1 | −1, +2, +1, −2 |
| Normal | 110110 | 0, +2, −2, −2 | 0, +2, −1, −1 | +1, +2, −2, −1 | +1, +2, −1, −2 |
| Normal | 110111 | −2, +2, −2, −2 | −2, +2, −1, −1 | −1, +2, −2, −1 | −1, +2, −1, −2 |
| Normal | 111000 | 0, 0, 0, +2 | +1, +1, 0, +2 | 0, +1, +1, +2 | +1, 0, +1, +2 |
| Normal | 111001 | −2, 0, 0, +2 | −1, +1, 0, +2 | −2, +1, +1, +2 | −1, 0, +1, +2 |
| Normal | 111010 | 0, −2, 0, +2 | +1, −1, 0, +2 | 0, −1, +1, +2 | +1, −2, +1, +2 |
| Normal | 111011 | −2, −2, 0, +2 | −1, −1, 0, +2 | −2, −1, +1, +2 | −1, −2, +1, +2 |
| Normal | 111100 | 0, 0, −2, +2 | +1, +1, −2, +2 | 0, +1, −1, +2 | +1, 0, −1, +2 |
| Normal | 111101 | −2, 0, −2, +2 | −1, +1, −2, +2 | −2, +1, −1, +2 | −1, 0, −1, +2 |
| Normal | 111110 | 0, −2, −2, +2 | +1, −1, −2, +2 | 0, −1, −1, +2 | +1, −2, −1, +2 |
| Normal | 111111 | −2, −2, −2, +2 | −1, −1, −2, +2 | −2, −1, −1, +2 | −1, −2, −1, +2 |
| xmt_err | XXXXXX | 0, +2, +2, 0 | +1, +1, +2, +2 | +2, +1, +1, +2 | +2, +1, +2, +1 |
| CSExtend_Err | XXXXXX | −2, +2, +2, −2 | −1, −1, +2, +2 | +2, −1, −1, +2 | +2, −1, +2, −1 |
| CSExtend | XXXXXX | +2, 0, 0, +2 | +2, +2, +1, +1 | +1, +2, +2, +1 | +1, +2, +1, +2 |
| CSReset | XXXXXX | +2, −2, −2, +2 | +2, +2, −1, −1 | −1, +2, +2, −1 | −1, +2, −1, +2 |

The equations between the bits and the symbols can be obtained by performing logical simplification according to Table 1. The first combination logical encoding unit 12a is designed with logical gates based on the computed equations, so that when system 1 wishes to transmit data, the first combination logical encoding unit 12a can perform logical operations to convert the first set of encryption data Sdₙ[8:0] to four-dimensional digital symbols {TA, TB, TC, TD}. There are various operational equations between bits and symbols. In order to simplify the disclosure of the present invention, only one example is shown. Note that however the example shown herein should not be construed as a limitation of the present invention. One kind of the bit-symbol operational equations is shown in the Table 2, as follows:

TABLE 2
Bit-symbol operational equation

| Symbol | Sdₙ[5] = 0 | Sdₙ[5] = 1 | |
|---|---|---|---|
| TA.bit2 | Sdₙ[0] | Sdₙ[4:3] = 00 | 0 |
| | | Otherwise | Sdₙ[0] |
| TA.bit1 | Sdₙ[0] | Sdₙ[4:3] = 00 | 1 |
| | | Otherwise | Sdn[0] |
| TA.bit0 | Sdₙ[4] | Sdₙ[4:3] = 00 | 0 |
| | | Sdₙ[4:3] = 01 | Sdₙ[6] \hat{ }Sdₙ[7] |
| | | Sdₙ[4:3] = 10 | Sdₙ[7] |
| | | Sdₙ[4:3] = 11 | Sdₙ[7] \hat{ }Sdₙ[8] |
| TB.bit2 | Sdₙ[1] | Sdₙ[4:3] = 00 | Sdₙ[0] |
| | | Sdₙ[4:3] = 01 or | Sdₙ[1] |
| | | Sdₙ[4:3] = 11 | |
| | | Otherwise | 0 |
| TB.bit1 | Sdₙ[1] | Sdₙ[4:3] = 00 or | Sdₙ[0] + Sdₙ[4] |
| | | Sdₙ[4:3] = 10 | |
| | | Sdₙ[4:3] = 01 or | Sdₙ[1] |
| | | Sdₙ[4:3] = 11 | |
| TB.bit0 | Sdₙ[4] \hat{ } | Sdₙ[4:3] = 00 | Sdₙ[6] |
| | Sdₙ[6] | Sdₙ[4:3] = 01 | Sdₙ[7] |
| | | Sdₙ[4:3] = 11 | Sdₙ[6] \hat{ }Sdₙ[7] \hat{ }Sdₙ[8] |
| | | Otherwise | 0 |
| TC.bit2 | Sdₙ[2] | Sdₙ[4:3] = 00 or | Sdₙ[1] |
| | | Sdₙ[4:3] = 10 | |
| | | Sdₙ[4:3] = 11 | Sdₙ[2] |
| | | Otherwise | 0 |
| TC.bit1 | Sdₙ[2] | Sdₙ[4:3] = 01 | 1 |
| | | Sdₙ[4:3] = 00 or | Sdₙ[1] |
| | | Sdₙ[4:3] = 10 | |
| | | Sdₙ[4:3] = 11 | Sdₙ[2] |
| TC.bit0 | Sdₙ[4] \hat{ } | Sdₙ[4:3] = 00 | Sdₙ[6] \hat{ }Sdₙ[7] |
| | Sdₙ[6] \hat{ } | Sdₙ[4:3] = 10 | Sdₙ[7] |
| | Sdₙ[7] | Sdₙ[4:3] = 11 | Sdₙ[6] \hat{ }Sdₙ[8] |
| | | Sdₙ[4:3] = 01 | 0 |
| TD.bit2 | Sdₙ[3] | Sdₙ[4:3] = 11 | 0 |
| | | Otherwise | Sdₙ[2] |
| TD.bit1 | Sdₙ[3] | | Sdₙ[2] + Sdₙ[4] * Sdₙ[3] |
| TD.bit0 | Sdₙ[4] \hat{ } | Sdₙ[4:3] = 00 | Sdₙ[7] \hat{ }Sdₙ[8] |
| | Sdₙ[7] \hat{ } | Sdₙ[4:3] = 01 | Sdₙ[6] \hat{ }Sdₙ[8] |
| | Sdₙ[8] | Sdₙ[4:3] = 10 | Sdₙ[6] \hat{ }Sdₙ[7] \hat{ }Sdₙ[8] |
| | | Sd_{D}[4:3] = 11 | 0 |

The data processing system of the present invention will now be explained in further details. For example, when Sdn[5]=0, Sdn[8:0]=001000101, the first combination logical encoding unit 12 performs the following logical operational equations:
TA.bit2=Sdn[0]=1,
TA.bit1=Sdn[0]=1,
TA.bit0=Sdn[4]=0,
Thus, TA=110 is computed, so TA=−2 according to above description. The rest may be deduced by analogy, the first combination logical encoding unit 12 perform logical operations to achieve TB=001, namely +1, TC=111, namely −1, and TD=000, namely 0. So, the first set of encryption data Sdn[8:0] is transformed to four-dimensional digital symbols {−2, +1, −1, 0}. Thus, a storage unit used in conventional technology can be eliminated, so as to reduce the cost of the production, and upgrade the reliability of data transmission.

The combination logical decoding unit 14a is designed with gates according to the operational equations for transformation between bits and symbols, which is the same as the first combination logical encoding unit 12a. There are various operational equations for transformation between bits and symbols that can be used. In order to simplify the description for the present invention, only one kind of the various operation equations is shown, but the present invention is not limited to this. One kind of the symbol-bit operational equations is shown in Table 3, a s follows:

TABLE 3
Symbol-bit operational equation

| Condition | Decoding bit |
|---|---|
| symbol∈{OOOO, EEEE} | Sdₙ[8:6] = 000 |
| symbol∈{OOEE, EEOO} | Sdₙ[8:6] = 010 |
| symbol∈{OEEO, EOOE} | Sdₙ[8:6] = 001 |
| symbol∈{OEOE, EOEO} | Sdₙ[8:6] = 011 |
| symbol∈{OOOE, EEEO} | Sdₙ[8:6] = 100 |
| symbol∈OOEO, EEOE} | Sdₙ[8:6] = 110 |
| symbol∈{OEEE, EOOO} | Sdₙ[8:6] = 101 |
| symbol∈{OEOO, EOEE} | Sdₙ[8:6] = 111 |
| TA = +2 | Sdₙ[5:0] = {3′b100, TD.bit1/2, |
| | TC.bit1/2, TB.bit1/2} |
| TC = +2 | Sdₙ[5:0] = {3′b101, TD.bit1/2, |
| | TB.bit1/2, TA.bit1/2} |
| TB = +2 | Sdₙ[5:0] = {3′b110, TD.bit1/2, |
| | TC.bit1/2, TA.bit1/2} |
| TD = +2 | Sdₙ[5:0] = {3′b111, TC.bit1/2, |
| | TB.bit1/2, TA.bit1/2} |
| Otherwise | Sdₙ[5:0] = {1′b0, TA.bit0, TD.bit1/2, |
| | TC.bit1/2, TB.bit1/2, TA.bit1/2} |

When system 1 receives four-dimensional analog symbols {A, B, C, D} transmitted from the remote electronic system 18 via the medium 17, the analog/digital symbol processing unit 13 converts the four-dimensional analog symbols to four-dimensional digital symbols {TA, TB, TC, TD}. The combination logical decoding unit 14a then performs logical operations to carry out a transformation from the four-dimensional digital symbols {TA, TB, TC, TD} to a second set of encryption data Sdn[8:0]. As shown in Table 3, the three most significant bits Sdn[8:6] of the second set of encryption data Sdn[8:0] are determined by one of the 8 subsets. The present invention is further illustrated with the following example, where {TA, TB, TC, TD} is {−2, −1, +1, −1} (i. e., {110, 111, 001, 111}). The combination logical decoding unit 14a performs the following operational equations:
Sdn[5]=0,
Sdn[4]=0,
Sdn[3]=1,
Sdn[2]=0,
Sdn[1]=1,
Sdn[0]=1.
Since the set {−2, −1, +1,−1} belongs to the subset {EOOO, OEEE}, the combination logical decoding unit 14a determines that Sdn[8:6]=101 via this logical operation. Thus, the second set of encryption data is Sdn[8:0]=101001011. In this way, the transformation from the digital symbols {TA, TB, TC, TD} to the second set of encryption data Sdn[8:0] can be carried out without using the storage unit as required by the lookup table employed in the conventional technology, thus reducing the production cost.

Moreover, the comparing unit 15 of the present invention provides an additional advantage. The comparing unit 15 may compare the first and second sets of four-dimensional digital symbols to check the validity of the first set. For example, the above set of four-dimensional digital symbols {−2, −1, +1, −1} is decoded to the second set of encryption data Sdn[8:0]=101001011 by the combination logical decoding unit 14a. Then, the second set of encryption data Sdn[8:0] is encoded again by the second combination logical encoding unit 14b to create a second set of four-dimensional digital symbols {−2, −1, +1,−1}. The comparing unit compares the first and second sets of four-dimensional digital symbols, and validates the first set of four-dimensional digital symbols {−2, −1, +1, −1} based on the matching of the two sets of digital symbols. Taking another example, a first set of four-dimensional digital symbols {+2, +2, +1, −1} is decoded by the combination logical decoding unit 14a by performing the operational equations shown in Table 3 to obtain a second set of encryption data Sdn[8:0]=010100100. Then, the second set of encryption data Sdn[8:0] is encoded again by the second combination logical encoding unit 14b to create a second set of four-dimensional digital symbols {+2, 0, +1,−1}. The comparing unit 15 compares the two sets of digital symbols and determines that the first set of four-dimensional digital symbol is invalid. In the case that the comparing unit 15 invalidates the first four-dimensional digital symbols, the Ethernet system can further perform a process to insure the validity of the data received by the system 1. The process performed by the Ethernet system is not within the scope of the present invention and will not be further discussed herein.

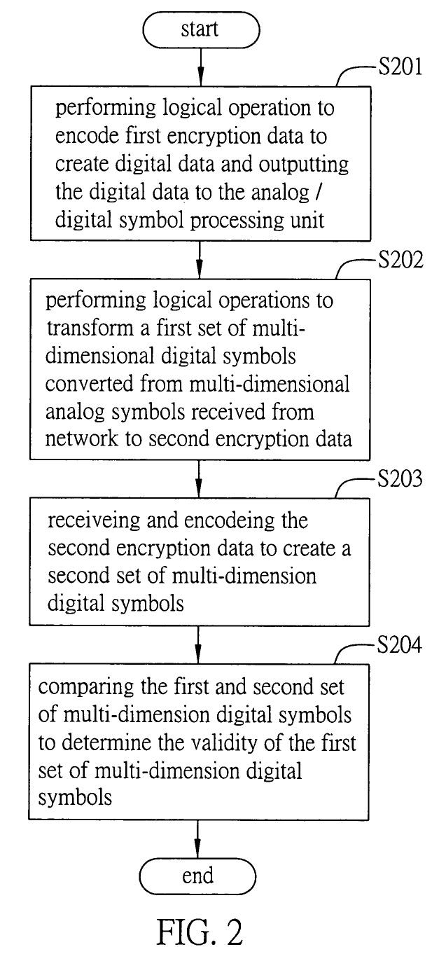

Referring to FIG. 2, which is a flowchart depicting a data processing method applied to the system 1 as shown in FIG. 1, the method comprises the following steps.

In step S201, the first combination logical encoding unit performs a logical operation to encode a first set of encryption data to create digital symbols, and outputs the digital symbols to the analog/digital symbol processing unit.

In step S202, the combination logical decoding unit performs a logical operation to decode a first set of multi-dimensional digital symbols into a second set of encryption data, wherein the first set of multi-dimensional digital symbols are converted from multi-dimensional analog symbols received from the network via the analog/digital symbol processing unit.

In step S203, the second combination logical encoding unit receives and encodes the second set of encryption data from the analog/digital symbol processing unit to create a second set of multi-dimensional digital symbols.

In the final step S204, the comparing unit compares the first set of multi-dimensional symbols and the second set of multi-dimensional symbols to check the validity of the first set of multi-dimensional digital symbols.

The multi-dimensional digital symbols can be four-dimensional symbol {TA, TB, TC, TD}, wherein, TA, TB, TC, TD□{+2, +1, 0, −1, −2}. The multi-dimensional analog symbols can be four-dimensional symbols {A, B, C, D}, wherein, A, B, C, D□{+2, +1, 0, −1, −2}. The symbols A, B, C and D are simultaneously transmitted to the medium in parallel, and transmitted to the remote electronic system by the medium. The system 1 can simultaneously perform data transmission and reception.

Compared with the conventional technology, the data processing system of the present invention can perform logical operations to carry out the transformation between bit data and symbols directly without using the storage unit as required by the lookup table employed in the conventional technology, thus reducing the cost of production. Additionally, the reliability of the data transmission can be ensured by means of checking the validity of the first set of multi-dimensional digital symbols.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A data processing system applicable to data transmission in an Ethernet, the system comprising:
a first combination logical encoding unit for performing logical operations to encode a first set of encryption data;
an analog/digital symbol processing unit for transforming the first set of encryption data received from the first combination logical encoding unit to a first set of multi-dimensional digital symbols;
a combination logical decoding unit for performing logical operations to decode the first set of multi-dimensional digital symbols converted by the analog/digital symbol processing unit from the network to create a second set of encryption data;
a second combination logical encoding unit for receiving the second set of encryption data and encoding the second set of encryption data to create a second set of multi-dimensional digital symbols; and
a comparing unit for comparing the first and second sets of multi-dimensional digital symbols to determine the validity of the first set of multi-dimensional digital symbols.

2. The system of claim 1, further comprising:
a data transmitting and receiving interface for transmitting and receiving data in the form of bit stream;
an encryption unit for receiving the bit stream transmitted by the data transmitting and receiving interface and encrypting into the first set of encryption data; and
a decryption unit for decrypting the second set of encryption data into digital data that is suitable for reception by the data transmitting and receiving interface.

3. The system of claim 2, further comprising:
a medium for transferring the multi-dimensional analog symbols; and
a remote electronic system for receiving and transmitting the multi-dimensional analog symbols via the medium.

4. The system of claim 1, wherein the Ethernet is based on the IEEE 802.3 standard.

5. The system of claim 1, wherein the data is an 8-bit data stream.

6. The system of claim 1, wherein the multi-dimensional digital symbols and analog symbols are four-dimensional digital symbols and analog symbols.

7. The system of claim 6, wherein the four-dimensional digital symbols are represented as {TA, TB, TC, TD}.

8. The system of claim 6, wherein the four-dimensional analog symbols are represented as {A, B, C, D}, the symbols A, B, C, D are simultaneously transmitted to the medium in parallel, and transmitted to the remote electronic system via the medium.

9. The system of claim 8, wherein {TA, TB, TC, TD} and {A, B, C, D} are permutations of four out of the combination of {+2, +1, 0, −1, −2}.

10. The system of claim 1, wherein the combination logical encoding unit and the combination logical decoding unit perform logical operations based on logical relationships between the first set of encryption data and the first set of multi-dimensional digital symbols and between the second set of encryption data and the second set of multi-dimensional digital symbols to carry out transformations between the first set of encryption data and the first set of multi-dimensional digital symbols and between the second set of multi-dimensional digital symbols and the second set of encryption data.

11. The system of claim 10, wherein mapping relationships between the first and second sets of encryption data and the multi-dimension digital symbols are predefined.

12. A data processing method applicable to a data processing system for data transmission in an Ethernet, the method comprising:
providing the data processing system for performing logical operations to encode and transform a first set of encryption data received from the Ethernet to a first set of multi-dimensional digital symbols;
providing the data processing system for performing logical operations to decode the first set of multi-dimensional digital symbols to create a second set of encryption data;
providing the data processing system for encoding the second encryption data to create a second set of multi-dimensional digital symbols; and
providing the data processing system for comparing the first and second sets of multi-dimensional digital symbols to determine the validity of the first set of multi-dimensional digital symbols.

13. The method of claim 12, wherein the multi-dimensional digital symbols and analog symbols are four-dimensional digital symbols and analog symbols.

14. The method of claim 13, wherein the four-dimensional digital symbols are represented as {TA, TB, TC, TD}.

15. The method of claim 12, wherein the four-dimensional analog symbols are represented as {A, B, C, D}, the symbols A, B, C, D are simultaneously transmitted to the medium in parallel, and transmitted to the remote electronic system via the medium.

16. The method of claim 15, wherein {TA, TB, TC, TD} and {A, B, C, D} are permutations of four out of the combination of {+2, +1, 0, −1, −2}.

17. The method of claim 12, wherein the Ethernet is based on the IEEE802.3 standard.
